(19) United States
(12) Patent Application Publication
(10) Pub. No.: US 2020/0008622 A1
(43) Pub. Date: Jan. 9, 2020

(54) COOKING PAN AND INSERT

(71) Applicant: U DESIGN LIMITED, Vogeltown, Wellington (NZ)

(72) Inventor: Jeremy Francis SKEGGS, Vogeltown, Wellington (NZ)

(73) Assignee: U DESIGN LIMITED, Vogeltown, Wellington (NZ)

(21) Appl. No.: 16/495,601

(22) PCT Filed: Mar. 16, 2018
(86) PCT No.: PCT/NZ2018/050031

§ 371 Date: Sep. 19, 2019

(30) Foreign Application Priority Data
Mar. 20, 2017 (NZ) 730260

(51) Int. Cl. A47J 37/10; A47J 36/02

(52) U.S. Cl. CPC A47J 37/108; A47J 36/02

(57) ABSTRACT

A cooking pan having channels suited for cooking food items such as sausages and an insert having channels to be placed in a pan. A plurality of ridges extending along the pan define longitudinal channels and ends of the ridges and pan side walls form transverse channels at the ends of the ridges. The design provides effective heat transfer, even cooking and shapes the food item during cooking.

### FIELD

This invention relates to a cooking pan having channels suited for cooking food items such as sausages and an insert having channels to be placed in a pan.

### BACKGROUND

Non-planar food items such as sausages have conventionally been cooked in flat pans. This provides poor heat transfer due to the limited contact area between a flat surface and a curved surface. Such conventional pans do not allow the sausage to be shaped during cooking and the typical curled sausage becomes difficult to cook on all sides due to its preference to lie along the plane of curvature.

Pans with shallow ridges have been provided. Whilst these provide some assistance with sausage positioning they provide limited additional surface contact and do not facilitate sausage shaping.

It is an object of the invention to provide an improved pan or pan insert or to at least provide the public with a useful choice.

### SUMMARY

According to one example embodiment there is provided a cooking pan comprising:
a. a base;
b. one or more side walls surrounding and extending upwardly from the base; and
c. a plurality of ridges extending along the pan and defining longitudinal channels having a profile in cross-section of generally constant radius.

According to another example embodiment there is provided a cooking pan comprising:
a. a base;
b. a pair of longitudinal side walls and a pair of transverse side walk surrounding and extending upwardly from the base; and
c. a plurality of ridges extending along the pan and defining longitudinal channels, wherein the ends of the ridges and transverse side walls form transverse channels at the ends of the ridges.

According to a further example embodiment there is provided an insert for a cooking pan comprising:
a. a base;
b. a plurality of ridges provided along the base defining a plurality of longitudinal channels between ridges having a generally semi-circular profile in cross-section.

There is also provided a cooking pan and insert including such an insert.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a perspective view of a pan having a plurality of integrally formed channels;

FIG. 2 is a plan view of the pan shown in FIG. 1;

FIG. 3 is a cross-sectional view along A-A of the pan shown in FIG. 2;

FIG. 4 is a cross-sectional view along B-B of the pan shown in FIG. 2;

FIG. 5 shows 6 long sausages positioned in the pan of FIGS. 1 to 4;

FIG. 6 shows 8 medium length sausages positioned in the pan of FIGS. 1 to 4;

FIG. 7 shows 10 short sausages positioned in the pan of FIGS. 1 to 4;

FIG. 8 shows 12 very short sausages positioned in the pan of FIGS. 1 to 4;

FIG. 9 shows a cross-sectional view of a small diameter sausage within a double compound channel;

FIG. 10 shows a cross-sectional view of a large diameter sausage within a double compound channel;

FIG. 11 shows a cross-sectional view of a small diameter sausage within a triple compound channel;

FIG. 12 shows a cross-sectional view of a medium diameter sausage within a triple compound channel;

FIG. 13 shows a cross-sectional view of a large diameter sausage within a triple compound channel; and

FIG. 14 shows a perspective view of a pan insert and a pan into which it is to be placed.

FIGS. 15-22 show perspective, front, left, bottom, rear, right and top views of a pan suitable for cooking 6 standard size sausages.

FIGS. 23-28 show perspective bottom, front, left, rear, right and top views of a pan suitable for cooking 10 standard size sausages.

### DETAILED DESCRIPTION

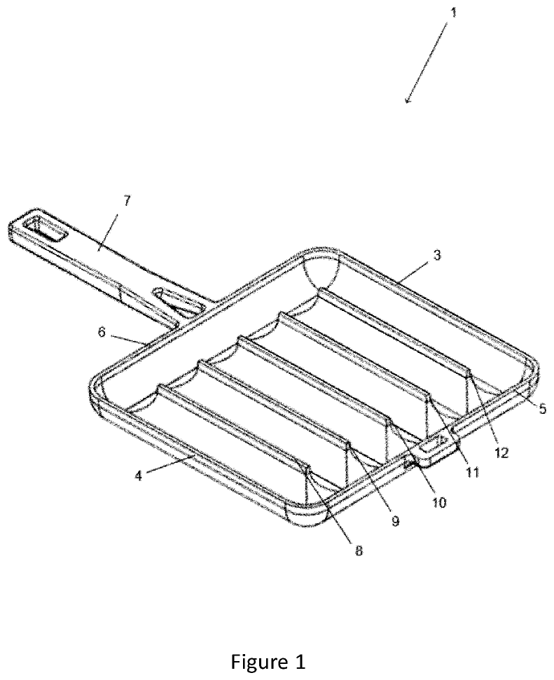

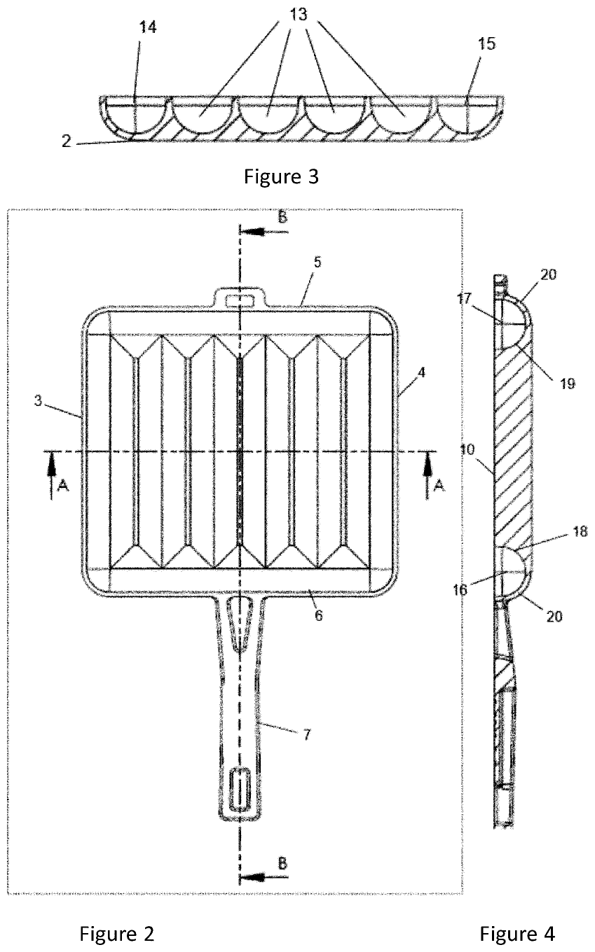

FIGS. 1 to 4 show a cooking pan 1 having a base 2 with longitudinal side walls 3 and 4 and lateral side walls 5 and 6 surrounding and extending upwardly from the base 2. The pan may suitably be formed from cast iron or aluminium with a base and wall thickness of between 3 to 5 mm, preferably 3.5 mm. The pan may suitably be about 250 mm wide, 180 mm long and 28 mm high, although the dimensions will depend upon the size of sausages and number to be accommodated. A handle 7 extends from lateral side wall 6. A plurality of longitudinal ridges 8 to 12 define internal channels 13 and outer channels 14 and 15. The outer channels 14 and 15 are defined both by the ridges 8 and 12 and longitudinal side walls 3 and 4. Whilst 6 longitudinal channels are shown in this embodiment it will be appreciated that the number of channels may vary with pan size and channel diameter. For example, 4 lateral channels may be suitable for a different sized pan.

The channels 13 to 15 are shown to have a semi-circular profile in cross-section in this example. It will be appreciated that the channel need not be perfectly semi-circular and simply needs to conform generally to the shape of the sausage to be cooked to ensure good heat transfer and shaping. A partially circular profile less than a semi-circle with generally constant radius will still be effective although with a decrease in heat transfer and shaping as its size decreases.

The channels may have a diameter of between 18 to 50 mm, with 18 to 30 mm being suitable for small diameter sausages, 30 to 38 mm being suitable for medium diameter sausages and 40 to 48 mm being suitable for large sausages.

Referring now to FIG. 4 it will be seen that lateral channels 16 and 17 are formed by the end profiles 18 and 19 of ridge 10 (likewise for ridges 8, 9, 11 and 12) and the profile of lateral walls 20. The lateral channels 16 and 17 are shown to have a semi-circular profile matching the profile of channels 13 to 15. Whilst the ends of the ridges do not provide full contact with a sausage located therein they provide partial walls that are effective to position and shape the sausage and the lateral walls 20 are in full contact with a quarter of the sausage to provide effective heat transfer.

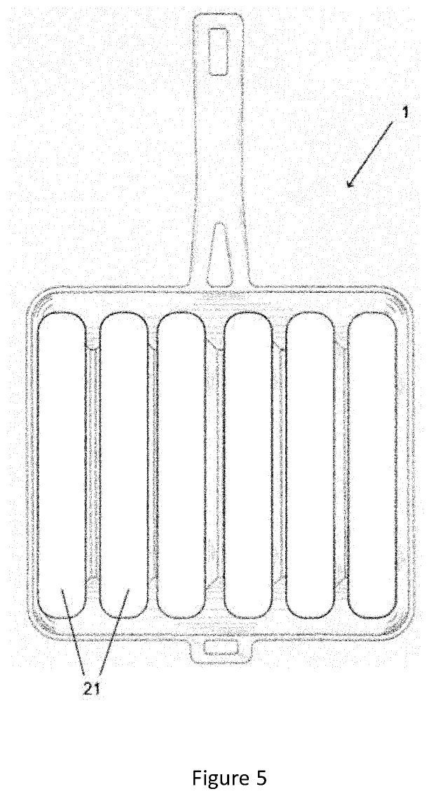

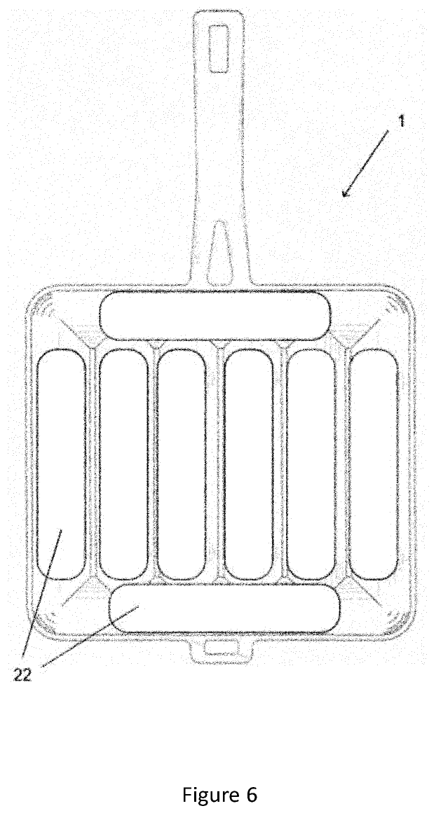

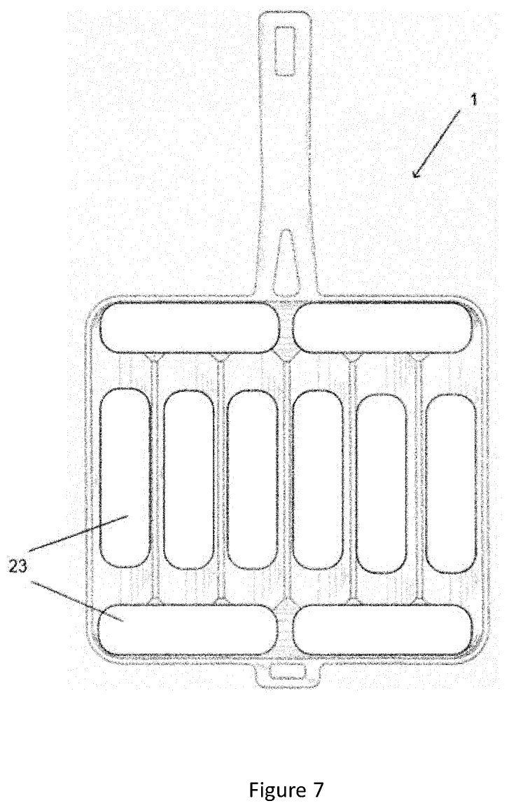

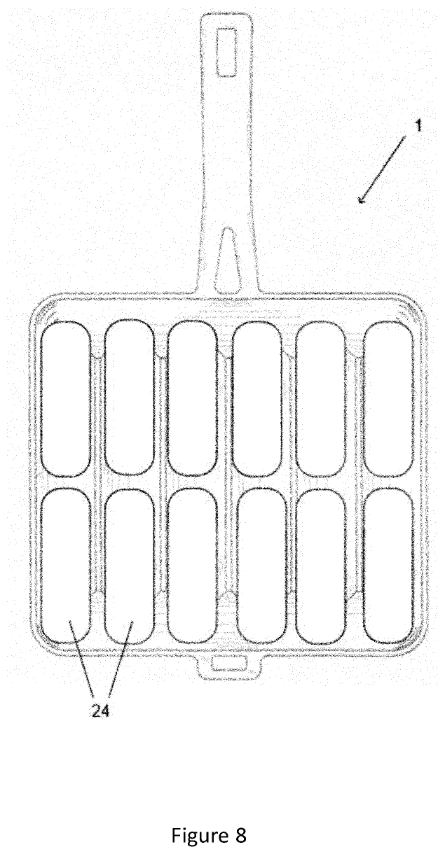

Referring now to FIG. 5 it will be seen that six long sausages 21 can be located within the six longitudinal channels of pan 1 providing good heat transfer and shaping along the length of the sausage. FIG. 6 illustrates how eight medium sausages 22 may be accommodated within the longitudinal and lateral channels of pan 1. FIG. 7 illustrates how ten short sausages 23 may be accommodated in the longitudinal and lateral channels. FIG. 8 illustrates how twelve very short sausages 24 may be accommodated in the longitudinal and lateral channels. It will thus be seen that the arrangement of longitudinal and lateral channels allows effective utilization of the entire pan area for different sizes of sausage.

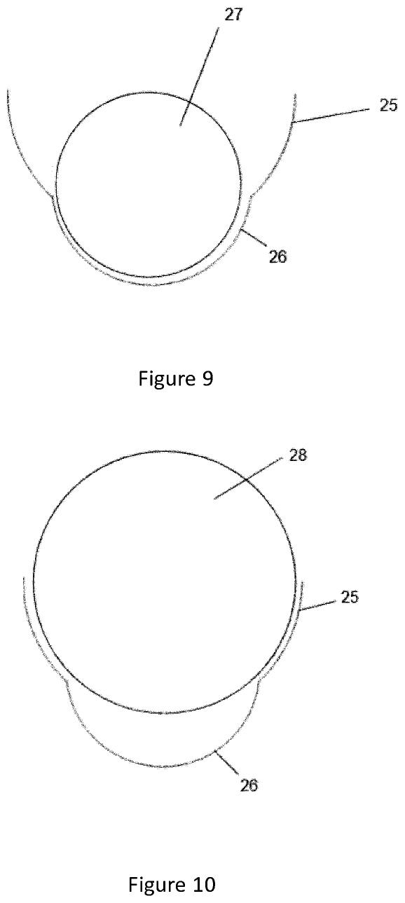

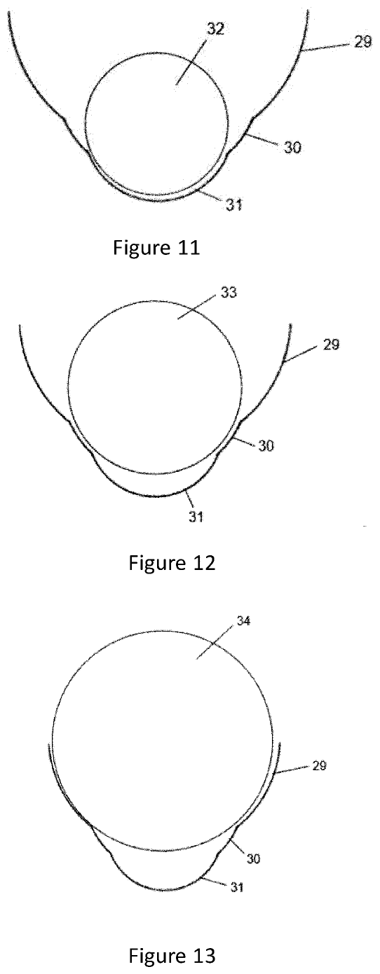

Referring now to FIGS. 9 and 10 a cross-sectional view of a compound channel profile is shown. In this embodiment each channel has an upper section 25 having a partial circular cavity of a first diameter and a lower section 26 having a partial circular cavity of a second diameter, smaller than the first diameter. In this way a channel may provide effective heat transfer to both a small sausage 27 (FIG. 9) and a large sausage 28 (FIG. 10). This concept may be extended to a compound channel profile having three sections as shown in FIGS. 11 to 13 where the channel profile is formed by an upper section 29 having a partial circular cavity of a first diameter; a middle section 30 having a partial circular cavity of a second diameter, smaller than the first diameter; and a lower section 31 having a partial circular cavity of a third diameter, smaller than the first and second diameters. In this way a single channel may provide effective heat transfer to a small diameter sausage 32, a medium diameter sausage 33 or a large diameter sausage 34.

There is a trade off between use of a constant diameter profile and a compound profile. Where predominantly one size of sausage is to be cooked a constant diameter profile is preferred due to its closer conformity to the shape of the sausage over the entire channel whereas the compound design is able to cook a wide range of sausages but with slightly reduced surface contact.

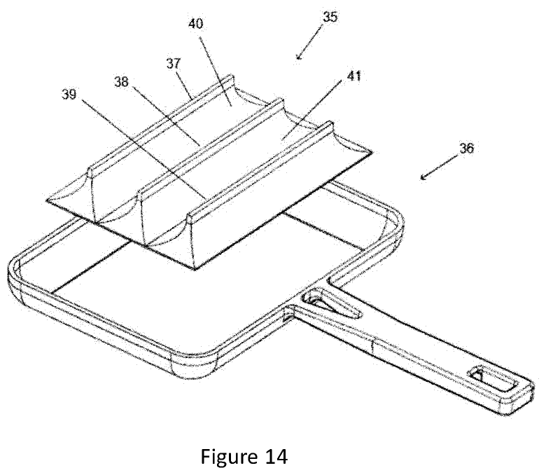

FIG. 14 shows an alternate design in which an insert 35 may be placed within a flat bottomed pan 36. In this way the insert may be used in a conventional pan to provide the advantages for cooking sausages as described above or the pan may be used as a conventional flat bottom pan. For simplicity the insert is shown with only 3 ridges 37 to 39 defining semi-circular channels 40 and 41. It will be appreciated that with curved side walls outer channels will be defined between ridges 37 and 39 and the side walls of pan 36. Likewise, the quarter circular end profiles of the ridges 37 to 39 and the sidewalls of the pan pay form lateral semi-circular channels as described above.

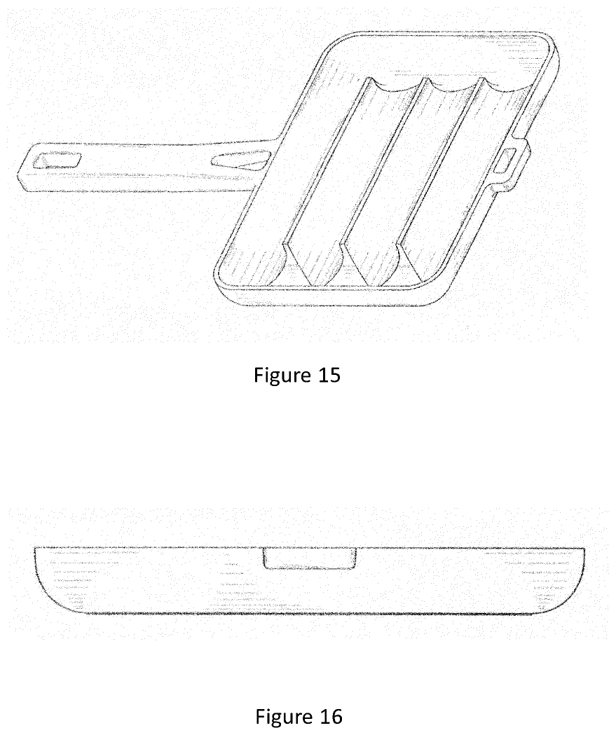

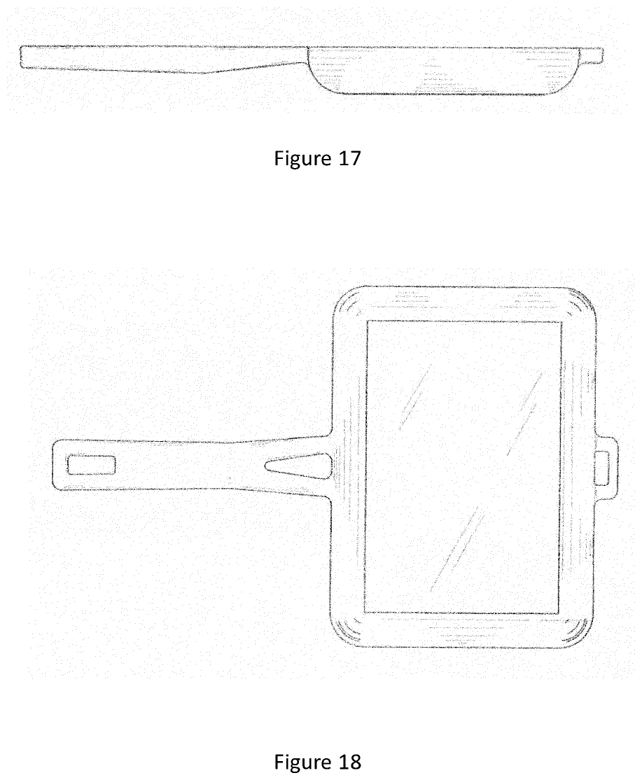

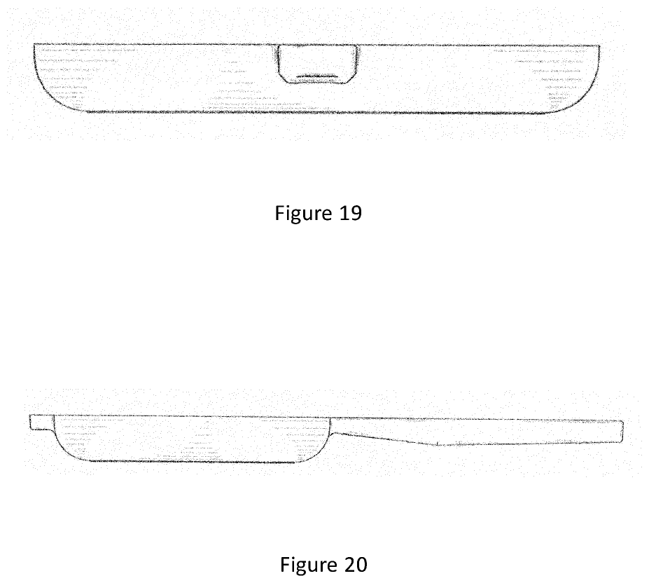

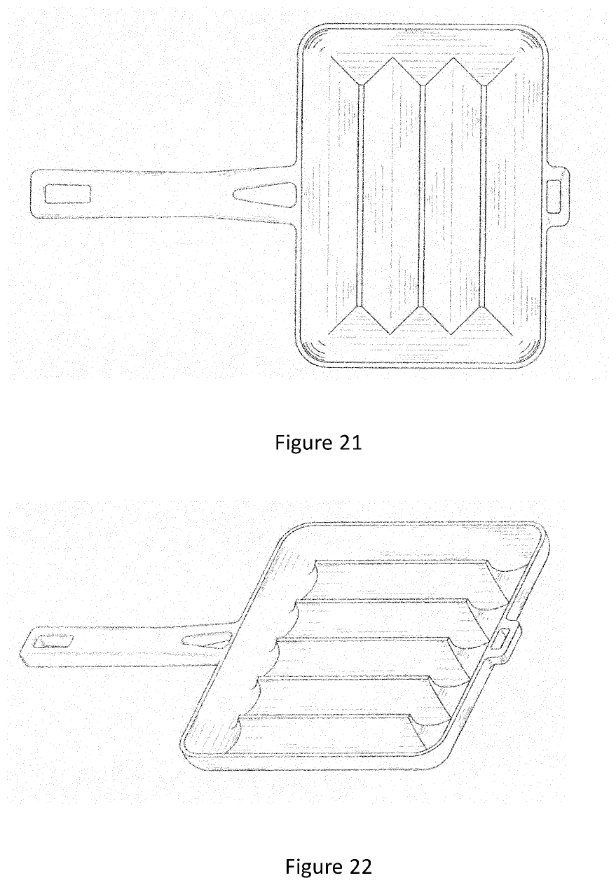

FIGS. 15-22 show perspective front, left, bottom, rear, right and top views of a pan suitable for cooking 6 standard size sausages.

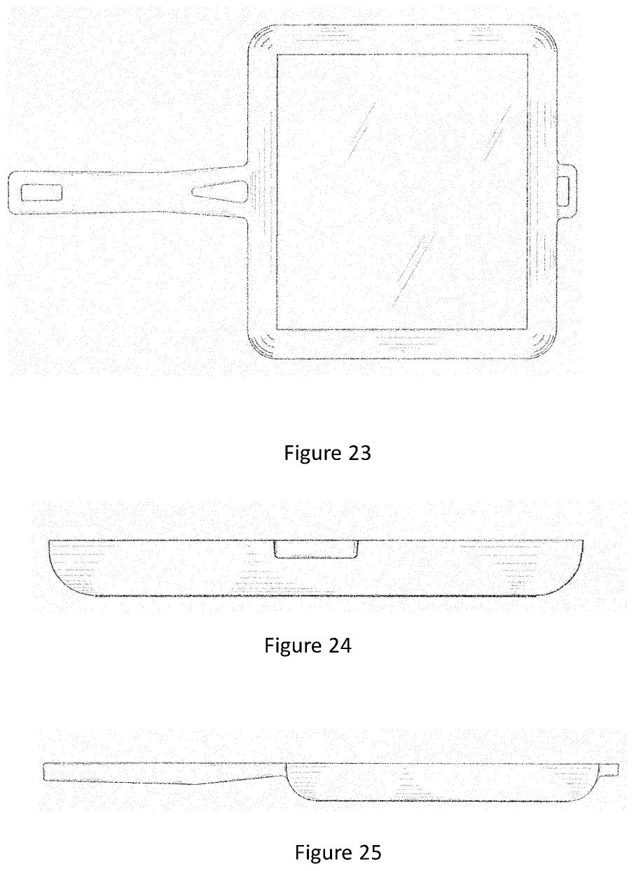

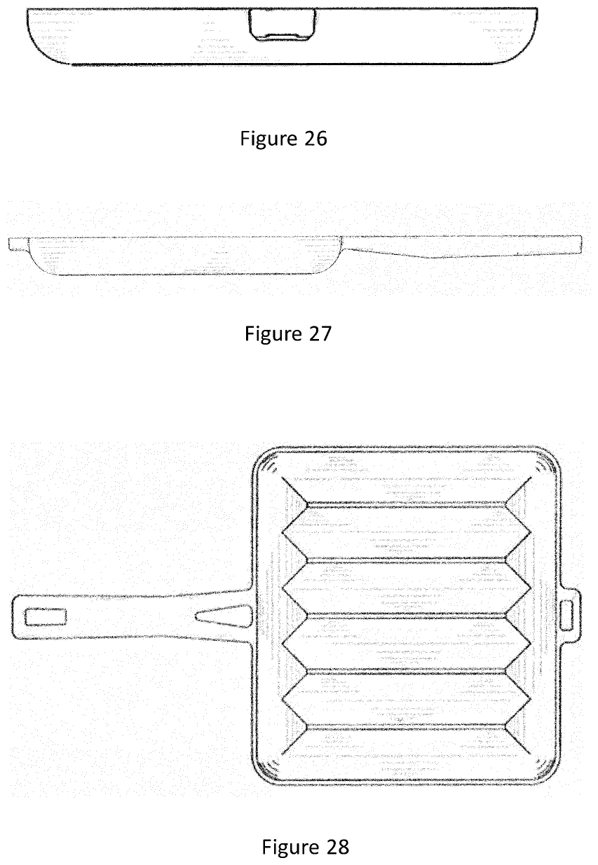

FIGS. 23-28 show perspective, bottom, front, left, rear, right and top views of a pan suitable for cooking 10 standard size sausages.

The shape of the channels in the above embodiments conform to the shape of a sausage to provide effective heat transfer over a large surface area of a sausage and even cooking. The channels allow easy sausage positioning and force the sausages into a straight shape to facilitate cooking on all sides. The quarter circular end profiles of the ridges provide lateral channels allowing better utilization of the pan area for a range of sausage sizes. The compound channel design allows one pan to effectively cook a wide range of sausage.

While the present invention has been illustrated by the description of the embodiments thereof, and while the embodiments have been described in detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept.

1. A cooking pan comprising:
a. a base;
b. one or more side walls surrounding and extending upwardly from the base; and
c. a plurality of ridges extending along the pan and defining longitudinal channels having a profile in cross-section of generally constant radius.

2. A cooking pan as claimed in claim 1 wherein the longitudinal channels have a generally semi-circular profile in cross-section.

3. A cooking pan as claimed in claim 1 wherein the cooking pan has longitudinal side walls in the direction of the ridges and transverse side walls transverse to the ridges.

4. A cooking pan as claimed in claim 3 wherein the interior walls of the longitudinal side walls are profiled so as to, in combination with adjacent ridges, form channels having a generally semi-circular profile in cross-section.

5. A cooking pan as claimed in claim 3 wherein the ends of the ridges and the interior walls of the transverse side walls are profiled so as to form partial transverse channels having a generally semi-circular profile in cross-section.

6. A cooking pan as claimed in claim 1 wherein the channels have a diameter of between 18 to 50 mm.

7.-11. (canceled)

12. A cooking pan as claimed in claim 1 having 4 longitudinal channels.

13. A cooking pan as claimed in claim 1 having 6 longitudinal channels.

14. A cooking pan comprising:
a. a base;
b. a pair of longitudinal side walls and a pair of transverse side walls surrounding and extending upwardly from the base; and
c. a plurality of ridges extending along the pan and defining longitudinal channels, wherein the ends of the ridges and transverse side walls form transverse channels at the ends of the ridges.

15. A cooking pan as claimed in claim 14 wherein the longitudinal channels and the transverse channels have the same profile.

16. A cooking pan as claimed in claim 14 wherein the longitudinal channels and the transverse channels have a generally semi-circular profile.

17. A cooking pan as claimed in claim 16 wherein the channels have a diameter of between 18 to 50 mm.

18.-20. (canceled)

21. A cooking pan as claimed in claim 14 wherein the longitudinal channels and the transverse channels have a compound profile formed by a plurality of circular sections of different diameters.

22. A cooking pan as claimed in claim 21 wherein the compound profile is formed by 2 circular sections of different diameters.

23. A cooking pan as claimed in claim 21 wherein the compound profile is formed by 3 circular sections of different diameters.

24.-27. (canceled)

28. An insert for a cooking pan comprising:
i. a base; and
ii. a plurality of ridges provided along the base defining a plurality of longitudinal channels between ridges having a generally semi-circular profile in cross-section.

29. An insert as claimed in claim 28 wherein the outer sides of the outer ridges have a generally quarter circular profile in cross-section.

30. An insert as claimed in claim 28 wherein the ridges have a generally quarter circular profile in cross-section at each end.

31. A cooking pan and insert comprising:
a. a cooking pan having a base with a pair of longitudinal side walls and a pair of transverse side walls surrounding and extending upwardly from the base; and
b. an insert as claimed in claim 27.

32. A cooking pan and insert as claimed in claim 31 wherein the interior side walls of the pan have a generally quarter circular profile in cross-section.
